(19) United States
(12) Patent Application Publication
(10) Pub. No.: US 2025/0062380 A1
(43) Pub. Date: Feb. 20, 2025

(54) ALKALI TRAP FOR MOLTEN CARBONATE FUEL CELL ANODE

(71) Applicant: Exxonmobil Technology and Engineering Company, Spring, TX (US)

(72) Inventors: Aaron SATTLER, Annandale, NJ (US); Gabor KISS, Hamton, NJ (US); Ramakrishnan VENKATARAMAN, Danbury, CT (US); April CORPUZ, Danbury, CT (US); Brandon O'NEILL, Spring, TX (US)

(21) Appl. No.: 18/804,530

(22) Filed: Aug. 14, 2024

Related U.S. Application Data
(60) Provisional application No. 63/533,048, filed on Aug. 16, 2023.

(51) Int. Cl. H01M 8/14; H01M 8/0612

(52) U.S. Cl. CPC H01M 8/145; H01M 8/0618; H01M 8/142; H01M 2008/147

(57) ABSTRACT

In various aspects, molten carbonate fuel cell configurations are provided that include a reforming catalyst and alkali traps integrated with one or more structures within the anode gas-collection volume. The purpose of the reforming catalyst is to reform methane (or some other reformable fuel) into hydrogen. In operation, alkali metals may migrate from the fuel cell electrolyte into the anode. Unless trapped, the alkali metals may deactivate the reforming catalyst. The alkali trap prolongs the operating life of reforming catalyst within the anode volume by capturing some portion of the alkali metal in the anode gas-collection volume. This reduces an amount of alkali metal that interacts with the reforming catalyst in the anode gas-collection volume. The prolonged life of the reforming catalyst prevents a decrease in catalyst activity.

### CROSS-REFERENCE TO RELATED APPLICATIONS

This Non-Provisional Patent application claims priority to U.S. Provisional Patent Application No. 63/533,048, filed Aug. 16, 2023, and titled “Alkali Trap For Molten Carbonate Fuel Cell Anode”, the entire contents of which is incorporated herein by reference.

### FIELD

Alkali traps for a molten carbonate fuel cell anode are provided, along with methods of operating such a fuel cell.

### BACKGROUND

This application discloses and claims subject matter made as a result of activities within the scope of a joint research agreement between ExxonMobil Technology and Engineering Company and FuelCell Energy, Inc. that was in effect on or before the effective filing date of the present application.

Molten carbonate fuel cells utilize hydrogen and/or other fuels to generate electricity. The hydrogen may be provided by reforming methane or other reformable fuels in a steam reformer, such as a steam reformer located upstream of the fuel cell or integrated within the fuel cell. Fuel can also be reformed in the anode cell in a molten carbonate fuel cell, which can be operated to create conditions that are suitable for reforming fuels in the anode. Still another option can be to perform some reforming both externally and internally to the fuel cell. Reformable fuels can encompass hydrocarbonaceous materials that can be reacted with steam and/or oxygen at elevated temperature and/or pressure to produce a gaseous product that comprises hydrogen.

The basic structure of a molten carbonate fuel cell includes a cathode, an anode, and a matrix between the cathode and anode that includes one or more molten carbonate salts that serve as the electrolyte. During conventional operation of a molten carbonate fuel cell, the molten carbonate salts partially diffuse into the pores of the cathode. This diffusion of the molten carbonate salts into the pores of the cathode provides an interface region where CO₂ can be converted into CO₃²⁻ for transport across the electrolyte to the anode.

In addition to these basic structures, volumes adjacent to the anode and cathode are typically included in the fuel cell. This allows an anode gas flow and a cathode gas flow to be delivered to the anode and cathode, respectively. In order to provide the volume for the cathode gas flow while still providing electrical contact between the cathode and the separator plate defining the outer boundary of the fuel cell, a cathode collector structure can be used. An anode collector can be used to similarly provide the volume for the anode gas flow.

### SUMMARY

In an aspect, a method for producing electricity in a molten carbonate fuel cell is provided. The method includes introducing an anode input stream comprising H₂, a reformable fuel, or a combination thereof into an anode gas-collection volume. The anode gas-collection volume is defined by an anode surface, a first separator plate, and an anode collector providing support between the anode surface and the first separator plate. The method also includes introducing a cathode input stream comprising O₂ and CO₂ into a cathode gas-collection volume. The cathode gas-collection volume being defined by a cathode surface, a second separator plate, and a cathode collector providing support between the cathode surface and the second separator plate. The method further including operating the molten carbonate fuel cell to generate electricity. The anode gas-collection volume includes one or more surfaces comprising a reforming catalyst and one or more surfaces comprising an alkali trap. The alkali trap comprises a material capable of adsorbing alkali.

In an aspect, a molten carbonate fuel cell is provided. The molten carbonate fuel cell comprises an anode, a first separator plate, and an anode collector in contact with the anode and the first separator plate to define an anode gas-collection volume between the anode and the first separator plate. The anode gas-collection volume is in fluid communication with an anode inlet. The molten carbonate fuel cell also comprises an alkali trap in contact with a surface on the anode collector, the alkali trap comprising a material capable of adsorbing alkali. The molten carbonate fuel cell also comprises a cathode, a second separator plate, and a cathode collector in contact with a cathode surface of the cathode and the second separator plate to define a cathode gas-collection volume between the cathode and the second separator plate. The cathode gas-collection volume is in fluid communication with a cathode inlet. The molten carbonate fuel cell also comprises an electrolyte matrix comprising an electrolyte between the anode and the cathode.

### BRIEF DESCRIPTION OF THE FIGURES

FIG. 1 shows a side view of an example of an anode collector structure with alkali traps.

FIG. 2 shows a perspective view of an example an anode collector structure with alkali traps.

FIG. 3 shows an example of a molten carbonate fuel cell.

### DETAILED DESCRIPTION OF THE EMBODIMENTS

### Overview

In various aspects, molten carbonate fuel cell configurations are provided that include a reforming catalyst and alkali traps integrated with one or more structures within the anode gas-collection volume. In an aspect, the structure is an anode current collector. The purpose of the reforming catalyst is to reform methane (or some other reformable fuel) into hydrogen. The hydrogen is then used as fuel in the anode. In operation, alkali metals may migrate from the fuel cell electrolyte and anode into the anode collection volume, thereby being able to interact with the reforming catalyst. Unless trapped, the alkali metals may deactivate the reforming catalyst. The alkali trap prolongs the operating life of reforming catalyst within the anode collection volume by capturing some portion of the alkali metal in the anode collection volume. This reduces an amount of alkali metal that interacts with the reforming catalyst in the anode collection volume. The prolonged life of the reforming catalyst arises from a slower catalyst activity reduction with time. Lower catalyst activity (i) leads to lower methane conversion causing lower maximum fuel utilization and (ii) decreases the cooling power (the reforming reaction is endothermic) reducing fuel cell life. Accordingly, the alkali trap described herein can prolong fuel cell life and maintain a higher fuel utilization for a longer period of time.

The electrolyte of a molten carbonate fuel cell typically corresponds to a one or more molten carbonates, such as a mixture of molten carbonates. The carbonates are typically alkali metal carbonates, such as lithium carbonate, sodium carbonate, potassium carbonate, and combinations thereof, although other alkali carbonates could potentially be used. Use of these and other electrolytes may allow alkali metals to migrate into the anode gas-collection volume from the electrolyte.

During operation of a molten carbonate fuel cell, carbon dioxide in the cathode is converted into carbonate ions. The carbonate ions are then transported across the electrolyte as a charge carrier, which facilitates the generation of electrical power by the fuel cell. When the carbonate ions reach the anode, the carbonate ions can diffuse into the porous structure of the anode to allow for reaction with hydrogen present in the volume defined by the anode current collector. The hydrogen can also diffuse into the porous structure of the anode to allow the reaction to proceed, so that carbonate ions and hydrogen can react to provide CO₂, H₂O, and electrons used to form the current provided by the fuel cell during operation.

In order to provide sufficient hydrogen in the volume defined by the anode current collector, one option is to include direct internal reforming elements in the volume defined by the anode current collector. For example, one or more surfaces that are exposed to the environment of the anode current collector volume can include reforming catalyst. These surfaces containing reforming catalyst are then exposed to any gases present in the volume defined by the anode current collector. In another example, reforming catalyst may be included in the anode gas-collection volume in the form of a pellet. Thus, to the degree that reformable hydrocarbons are present, such hydrocarbons can be reformed by coming into contact with the reforming catalyst under the typical temperature conditions present within the molten carbonate fuel cell.

At the operating temperatures for molten carbonate fuel cells, the alkali metals in the electrolyte can have a small but non-zero vapor pressure. Due to the porous nature of the anode, this vapor pressure of alkali metal(s) can allow gas phase alkali metal(s) to diffuse into the volume defined by the anode current collector. This means that any reforming catalyst that is exposed to the environment within the anode current collector is also potentially exposed to alkali metals. Unfortunately, the alkali metals can act as catalyst poisons for reforming catalysts, resulting in substantial drops in reforming catalyst activity as the reforming catalyst is exposed to alkali metal vapor over time.

In various aspects, one option for reducing or minimizing reforming catalyst deactivation due to alkali metal vapor in the volume defined by the anode current collector is to provide an alkali metal trap material within the volume defined by the anode current collector. Preferably, the alkali metal trap material can be provided at a location so that alkali metal vapor diffusing through the porous anode will encounter the alkali metal trap material prior to coming into contact with reforming catalyst. This can be achieved, for example, by including portions of alkali metal trap materials on the anode current collector structure while having the reforming catalyst present on surfaces that are opposite from the anode within the anode current collector volume. The alkali metal trap material can be any convenient material that can bind alkali metals while remaining stable under the conditions present within the gas phase environment of the anode current collector. Examples of suitable alkali metal trap materials include, but are not limited to, alumina and/or silica-alumina materials. This can include crystalline silica-alumina materials, such as materials having a zeotype framework structure.

### Definitions

Reformable Fuel: Reformable fuel is defined as any compound that contains sufficient amounts of hydrogen atoms and carbon atoms so that the compound can be at least partially converted in H₂ and carbon oxides under conditions suitable for hydrocarbon reforming. Alcohols are an example of non-hydrocarbon compounds that can also be reformed to produce at least H₂ and carbon oxides.

Fuel cell and fuel cell stack definitions: In this discussion, a fuel cell can correspond to a single cell, with an anode and a cathode separated by an electrolyte. The anode and cathode can receive input gas flows to facilitate the respective anode and cathode reactions for transporting charge across the electrolyte and generating electricity. A fuel cell stack can represent a plurality of cells in an integrated unit. Although a fuel cell stack can include multiple fuel cells, the fuel cells can typically be connected in parallel and can function (approximately) as if they collectively represented a single fuel cell of a larger size. When an input flow is delivered to the anode or cathode of a fuel cell stack, the fuel stack can include flow channels for dividing the input flow between each of the cells in the stack and flow channels for combining the output flows from the individual cells. In this discussion, a fuel cell array can be used to refer to a plurality of fuel cells (such as a plurality of fuel cell stacks) that are arranged in series, in parallel, or in any other convenient manner (e.g., in a combination of series and parallel). A fuel cell array can include one or more stages of fuel cells and/or fuel cell stacks, where the anode/cathode output from a first stage may serve as the anode/cathode input for a second stage. It is noted that the anodes in a fuel cell array do not have to be connected in the same way as the cathodes in the array. For convenience, the input to the first anode stage of a fuel cell array may be referred to as the anode input for the array, and the input to the first cathode stage of the fuel cell array may be referred to as the cathode input to the array. Similarly, the output from the final anode/cathode stage may be referred to as the anode/cathode output from the array.

It should be understood that reference to use of a fuel cell herein typically denotes a “fuel cell stack” composed of individual fuel cells, and more generally refers to use of one or more fuel cell stacks in fluid communication. Individual fuel cell elements (plates) can typically be “stacked” together in a rectangular array called a “fuel cell stack”. This fuel cell stack can typically take a feed stream and distribute reactants among all of the individual fuel cell elements and can then collect the products from each of these elements. When viewed as a unit, the fuel cell stack in operation can be taken as a whole even though composed of many (often tens or hundreds) of individual fuel cell elements. These individual fuel cell elements can typically have similar voltages (as the reactant and product concentrations are similar), and the total power output can result from the summation of all of the voltages in all of the cell elements, when the elements are electrically connected in series. Stacks can also be arranged in a series arrangement to produce high voltages. A parallel arrangement can boost the current. If a sufficiently large volume fuel cell stack is available to process a given exhaust flow, the systems and methods described herein can be used with a single molten carbonate fuel cell stack. In other aspects of the invention, a plurality of fuel cell stacks may be desirable or needed for a variety of reasons.

For the purposes of this invention, unless otherwise specified, the term “fuel cell” should be understood to also refer to and/or is defined as including a reference to a fuel cell stack composed of set of one or more individual fuel cell elements for which there is a single input and output, as that is the manner in which fuel cells are typically employed in practice. Similarly, the term fuel cells (plural), unless otherwise specified, should be understood to also refer to and/or is defined as including a plurality of separate fuel cell stacks. In other words, all references within this document, unless specifically noted, can refer interchangeably to the operation of a fuel cell stack as a “fuel cell”. For example, the volume of exhaust generated by a commercial scale combustion generator may be too large for processing by a fuel cell (i.e., a single stack) of conventional size. In order to process the full exhaust, a plurality of fuel cells (i.e., two or more separate fuel cells or fuel cell stacks) can be arranged in parallel, so that each fuel cell can process (roughly) an equal portion of the combustion exhaust. Although multiple fuel cells can be used, each fuel cell can typically be operated in a generally similar manner, given its (roughly) equal portion of the combustion exhaust.

In this discussion, a zeotype is defined to refer to a crystalline material having a porous framework structure built from tetrahedra atoms connected by bridging oxygen atoms. Examples of known zeotype frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. Under this definition, a zeolite refers specifically to an aluminosilicate having a zeotype framework structure. Under this definition, a zeotype can refer to aluminosilicates (i.e., zeolites) having a zeotype framework structure as well as crystalline structures containing oxides of heteroatoms different from silicon and aluminum. Such heteroatoms can include any heteroatom generally known to be suitable for inclusion in a zeotype framework, such as gallium, boron, germanium, phosphorus, zinc, and/or other transition metals that can substitute for silicon and/or aluminum in a zeotype framework. It is noted that under this definition, a zeotype can include materials such as silicoaluminophosphate (SAPO) materials or aluminophosphate (AlPO) materials.

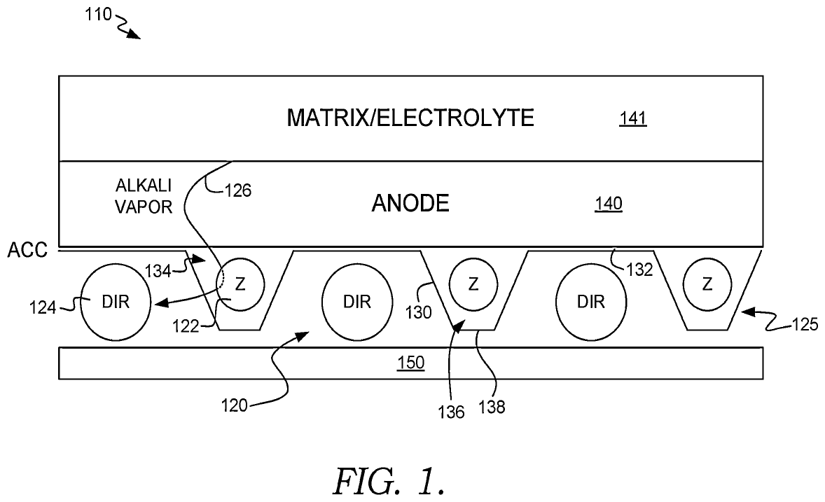

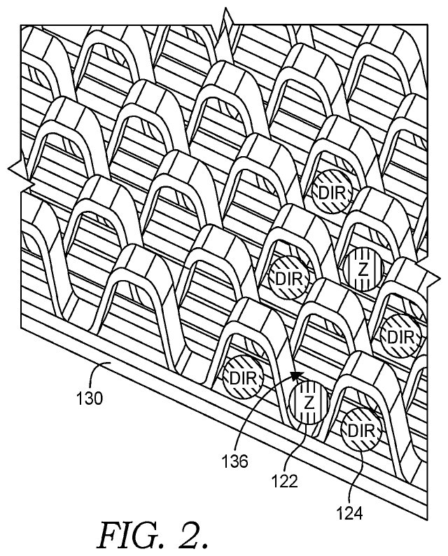

FIG. 1 shows an example of a side view 110 of an anode gas-collection volume 120 that includes an anode collector structure 130. In side view 110 of FIG. 1, anode input gas 125 is introduced into the anode gas-collection volume 120 that is defined by the separation or gap between anode 140 and separator plate 150 (such as a bipolar plate). Of course, the opposing side of anode 140 is adjacent to the electrolyte 141. The anode collector 130 provides structural support to maintain the gap corresponding to anode gas-collection volume 120. The structural support is provided by solid portions of the anode collector 130. As shown in perspective view 210 in FIG. 2, the portions correspond to solid portions, but in various aspects, the structural support provided by an anode collector may be provided by hollow structures or shell structures that reduce or minimize the blockage of the flow cross-section due to the structures.

In FIG. 1, upper surface 132 of the collector 130 corresponds to a plate-like surface that includes a regular pattern of openings 134. The openings 134 in surface 130 were formed by punching the surface to form loop structures 136 that extend below the plane of surface 130. In a conventional configuration, the upper surface 132 would be placed in contact with an anode surface, while loop structures 136 would extend to support a bipolar plate, separator plate, or other plate structure that is used to define the volume for receiving an anode input gas. The plate structure would contact loop structures 136 at the bottom edge 138 of the loop structures.

The spacing and size of the openings may vary. For example, the spacing between openings may be roughly the same distance as the length of the openings 134. As shown in FIG. 2, the spacing between the openings may be roughly half of the width of the openings 134.

FIG. 1 shows reforming catalyst 124 and alkali traps 122 in an alternating pattern. The alkali traps may be located in open portions of loops 136 that are not occluded from the anode 140 surface by portions of the anode current collector. The reforming catalyst 124 may be positioned in pockets created by the loops 136. This arrangement may create a route 126 for alkali metals that cause the alkali metals to come in contact with the alkali trap 122 before coming into contact with the reforming catalyst 124. In practice, this arrangement with the alkali traps upstream of the reforming catalyst, where the anode is the source of alkali metals may maximize the effectiveness of the alkali traps. Nevertheless, other arrangements are possible, including a random mixing of catalyst and alkali traps.

In one aspect, both the alkali traps and reforming catalyst take the form of pellets. In order to manufacture an anode current collector with both reforming catalyst and alkali traps, the catalyst may be installed on a first side of the current collector and then held in place with a plastic film or sheet. The plastic sheet may be installed parallel to and in the same plane as the lower surface 138. In this arrangement, an upper portion (defined by the installed position) of the catalyst may be in contact with the current collector 130 and the lower portion with the plastic film. The alkali trap may be installed by rotating the current collector and locating the alkali traps within the loops 136. A second plastic sheet may be installed parallel to and in the same plane as the upper surface 132 of the collector 130 to hold the alkali trap in place.

Once installed within the anode of the fuel cell, the first and second plastic sheets will be burned off during conditioning of the fuel cell. The surface of the anode 140 and surface of the separator plate may then hold the alkali trap and reforming catalyst in place during operating. As an alternative to mechanical compression, adhesive may be used secure the alkali trap and reforming catalyst. Alternatively, the alkali trap and/or catalyst may take a form that can be applied to a surface of the anode current collector.

Though depicted in a 1:1 ratio of reforming catalyst to alkali trap, other ratios are possible, such as 1:2, 1:3, 1:4, 1:6, 1:9 1:15, 15:1, 9:1, 6:1, 4:1, 3:1, 2:1 or similar ratios, including those in between the ratios provided. The optimal ratio may vary depending on a number of operating parameters. Under some MCFC operating conditions, a 4:1 catalyst to alkali trap ratio was found to be effective.

Turning now to FIG. 2, a perspective view of the anode collector with reforming catalyst 124 and alkali traps 122 is provided. As can be seen, the loop pattern of FIG. 1 may be followed with the openings 134 staggered in adjacent rows.

The alkali traps in combination with anode reforming described here can provide additional benefits when operating an MCFC to have enhanced CO₂ utilization. One difficulty in using MCFCs for elevated CO₂ utilization is that the operation of the fuel cell can potentially be kinetically limited if one or more of the reactants required for fuel cell operation is present in low quantities. For example, when using a cathode input stream with a CO₂ content of 4.0 vol % or less, achieving a CO₂ utilization of 75% or more corresponds to a cathode outlet concentration of 1.0 vol % or less. However, a cathode outlet concentration of 1.0 vol % or less does not necessarily mean that the CO₂ is evenly distributed throughout the cathode. Instead, the concentration will typically vary within the cathode due to a variety of factors, such as the flow patterns in the anode and the cathode. The variations in CO₂ concentration can result in portions of the cathode where CO₂ concentrations substantially below 1.0 vol % are present.

One of the advantages of transport of alternative ions across the electrolyte is that the fuel cell can continue to operate, even though a sufficient number of CO₂ molecules are not kinetically available. This can allow additional CO₂ to be transferred from cathode to anode even though the amount of CO₂ present in the cathode would conventionally be considered insufficient for normal fuel cell operation. This can allow the fuel cell to operate with a measured CO₂ utilization closer to 100%, while the calculated CO₂ utilization (based on current density) can be at least 3% greater than the measured CO₂ utilization, or at least 5% greater, or at least 10% greater, or at least 20% greater. It is noted that alternative ion transport can allow a fuel cell to operate with a current density that would correspond to more than 100% calculated CO₂ utilization.

### Hydrocarbon Reforming in a Molten Carbonate Fuel Cell Anode

As an example of operating conditions in which anode reforming may occur, the anode input of a molten carbonate fuel cell is a feed containing roughly 15 vol % to 25 vol % of a reformable hydrocarbon fuel (such as methane) and 5.0 vol % to 10 vol % of a H₂. The input flow to the anode may contain 1.0 vol % or less of CO and 1.0 vol % or less of CO₂. In systems where an external reformer is used upstream of the anode, the flow into the anode input is modified due to at least partial reforming of the hydrocarbons in the external reformer. However, the increase in CO and/or CO₂ into the anode input is offset by a decrease in the amount of reformable hydrocarbon that is passed into the anode input. Regardless of whether an external reformer is used or not, a conventional output flow from the anode corresponds to utilization of roughly 65% to 75% of the fuel passed into the molten carbonate fuel cell.

Hydrocarbon reforming is facilitated by placing a reforming catalyst in the anode volume. The reforming catalyst may comprises a metal combined with a substrate. The metal portion of the reforming catalyst may comprise such metals as rhodium (Rh), ruthenium (Ru), iridium (Ir), palladium (Pd), platinum (Pt), molybdenum (Mo), tungsten (W), iron (Fe), cobalt (Co), chromium (Cr), cerium (Ce), copper (Cu), magnesium (Mg), aluminum (Al), and/or nickel (Ni). The substrate can take many forms. In one aspect, the substrate is primarily composed of silicon (Si). In one embodiment, the reforming catalyst takes the form of a pellet. In another embodiment, the reforming catalyst may be applied to a surface of the anode current collector or other surface within the anode volume.

### Alkali Trap

The alkali metal trap material can be any convenient material that can bind alkali metals while remaining stable under the conditions present within the gas phase environment of the anode current collector. The alkali metal trap may take the form of a pellet and/or a surface coating. If a surface coating, the alkali metal trap may be applied to portions of the anode current collector. In an aspect, one side of the anode current collector is coated with alkali metal trap material and the opposite side is coated with reforming catalyst. In this embodiment, the side coated with the alkali metal trap may be installed facing the anode surface. Examples of suitable alkali metal trap materials include, but are not limited to, alumina and/or silica-alumina materials. This can include crystalline silica-alumina materials, such as materials having a zeotype framework structure. It is noted that zeotypes can include framework materials in addition to and/or different from silicon and aluminum, while zeolites correspond to zeotype framework materials with only silicon and aluminum atoms in the zeotype framework. It is noted that within this description, unless otherwise specified, alumina materials refer to any material including alumina, while silica-alumina materials refer to materials any materials including both silica and alumina. Thus, silica-alumina materials can potentially also include atoms other than silicon, aluminum, and oxygen. In some aspects, the alkali metal trap material can consist essentially of alumina, silica-alumina, or a combination thereof. In such aspects, the alkali metal trap material can include less than 0.1 mole percent of atoms different from silicon, aluminum, and oxygen.

A wide variety of zeotype framework materials and/or amorphous materials can potentially be used as alkali metal trap materials. Due to the relatively small size of lithium, sodium, and potassium, materials with relatively small pore sizes can be suitable. For crystalline materials (such as zeotype materials), zeotype framework structures having 8-member rings, 10-member rings, and/or 12-member rings can all be suitable for use as alkali metal trap materials. More generally, alumina and/or silica-alumina materials (including crystalline materials) having pore sizes of 4.0 Angstroms or more, or 5.0 Angstroms or more, or 6.0 Angstroms or more, such as up to 20 Angstroms or possibly still larger, can be suitable for use as alkali trap materials. In such aspects, the alumina and/or silica-alumina material can have a total surface area of 50 m²/g or more, or 150 m²/g or more, or 250 m²/g or more, or 400 m²/g or more, such as up to 1000 m²/g or possibly still higher. Additionally or alternately, the alumina and/or silica-alumina material can have a micropore surface area of 50 m²/g or more, or 100 m²/g or more, or 200 m²/g or more, such as up to 800 m²/g or possibly still higher.

In an embodiment, the material for the alkali trap may be a mixture of 80% HSZ-360HUA and 20% V300. HSZ-360HUA may be obtained from Tosoh-USA, it is a USY Zeolite having a H+ cation, 15:1 SiO2/Al2O3, 550 m2/g BET, and 0.2-0.4 μm crystal size. V300 is Versal 300 alumina. Ratios other than 80% to 20% are possible, such as 90% to 10%, 70% to 30%, 60% to 40%, 50% to 50%, 40% to 60%, 30% to 70%, 20% to 80%, 10% to 90% and the like.

Conditions for Molten Carbonate Fuel Operation with Alternative Ion Transport

In various aspects, the operating conditions for a molten carbonate fuel cell (such as a cell as part of a fuel cell stack) can be selected to correspond to a transference of 0.97 or less, thereby causing the cell to transport both carbonate ion and at least one type of alternative ion across the electrolyte. In addition to transference, operating conditions that can indicate that a molten carbonate fuel cell is operating with transport of alternative ions include, but are not limited to, CO₂ concentration for the cathode input stream, the CO₂ utilization in the cathode, the current density for the fuel cell, the voltage drop across the cathode, the voltage drop across the anode, and the O₂ concentration in the cathode input stream. Additionally, the anode input stream and fuel utilization in the anode can be generally selected to provide the desired current density.

Generally, to cause alternative ion transport, the CO₂ concentration in at least a portion of the cathode needs to be sufficiently low while operating the fuel cell to provide a sufficiently high current density. Having a sufficiently low CO₂ concentration in the cathode typically corresponds to some combination of a low CO₂ concentration in the cathode input flow, a high CO₂ utilization, and/or a high average current density. However, such conditions alone are not sufficient to indicate a transference of 0.97 or less, or 0.95 or less.

For example, a molten carbonate fuel cell with a cathode open area of roughly 33% was operated with a CO₂ cathode inlet concentration of 19 vol %, 75% CO₂ utilization, and 160 mA/cm² of average current density. These conditions corresponded to a difference between calculated CO₂ utilization and measured CO₂ utilization of less than 1%. Thus, the presence of substantial alternative ion transport/a transference of 0.97 or less, or 0.95 or less, cannot be inferred simply from the presence of a high CO₂ utilization and a high average current density.

As another example, a molten carbonate fuel cell with a cathode open area of between 50% and 60% was operated with a CO₂ cathode inlet concentration of 4.0 vol %, 89% CO₂ utilization, and 100 mA/cm² of current density. These conditions corresponded to a transference of at least 0.97. Thus, the presence of a transference of 0.95 or less/substantial alternative ion transport cannot be inferred simply from the presence of high CO₂ utilization in combination with low CO₂ concentration in the cathode input stream.

As still another example, a molten carbonate fuel cell with a cathode open area of between 50% and 60% was operated with a CO₂ cathode inlet concentration of 13 vol %, 68% CO₂ utilization, and 100 mA/cm² of current density. These conditions corresponded to a transference of at least 0.98.

In this discussion, operating an MCFC to transport alternative ions across the electrolyte is defined as operating the MCFC so that more than a de minimis amount of alternative ions are transported. It is possible that minor amounts of alternative ions are transported across an MCFC electrolyte under a variety of conventional conditions. Such alternative ion transport under conventional conditions can correspond to a transference of 0.98 or more, which corresponds to transport of alternative ions corresponding to less than 2.0% of the current density for the fuel cell.

In this discussion, operating an MCFC to cause alternative ion transport is defined as operating an MCFC with a transference of 0.95 or less, so that 5.0% or more of the current density (or, 5.0% or more of the calculated CO₂ utilization) corresponds to current density based on transport of alternative ions, or 10% or more, or 20% or more, such as up to 35% or possibly still higher. It is noted that in some aspects, operating with increased open area and/or reduced unblocked flow cross-section can reduce or minimize the amount of alternative ion transport under conditions that would otherwise result in a transference of 0.95 or less. Thus, by operating with increased open area and/or reduced unblocked flow cross-section, some operating conditions with elevated CO₂ capture/substantial alternative ion transport may correspond to a transference of 0.97 or less.

In this discussion, operating an MCFC to cause substantial alternative ion transport (i.e., to operate with a transference of 0.95 or less, or 0.97 or less with increased open area and/or reduced unblocked flow cross-section) is further defined to correspond to operating an MCFC with voltage drops across the anode and cathode that are suitable for power generation. The total electrochemical potential difference for the reactions in a molten carbonate fuel cell is ˜1.04 V. Due to practical considerations, an MCFC is typically operated to generate current at a voltage near 0.7 V or about 0.8 V. This corresponds to a combined voltage drop across the cathode, electrolyte, and anode of roughly 0.34 V. In order to maintain stable operation, the combined voltage drop across the cathode, electrolyte, and anode can be less than ˜0.5 V, so that the resulting current generated by the fuel cell is at a voltage of 0.55 V or more, or 0.6 V or more.

With regard to the anode, one condition for operating with substantial alternative ion transport can be to have an H₂ concentration of 8.0 vol % or more, or 10 vol % or more in the region where the substantial alternative ion transport occurs. Depending on the aspect, this could correspond to a region near the anode inlet, a region near the cathode outlet, or a combination thereof. Generally, if the H₂ concentration in a region of the anode is too low, there will be insufficient driving force to generate substantial alternative ion transport.

Suitable conditions for the anode can also include providing the anode with H₂, a reformable fuel, or a combination thereof, and operating with any convenient fuel utilization that generates a desired current density, including fuel utilizations ranging from 20% to 80%. In some aspects this can correspond to a traditional fuel utilization amount, such as a fuel utilization of 60% or more, or 70% or more, such as up to 85% or possibly still higher. In other aspects, this can correspond to a fuel utilization selected to provide an anode output stream with an elevated content of H₂ and/or an elevated combined content of H₂ and CO (i.e., syngas), such as a fuel utilization of 55% or less, or 50% or less, or 40% or less, such as down to 20% or possibly still lower. The H₂ content in the anode output stream and/or the combined content of H₂ and CO in the anode output stream can be sufficient to allow generation of a desired current density. In some aspects, the H₂ content in the anode output stream can be 3.0 vol % or more, or 5.0 vol % or more, or 8.0 vol % or more, such as up to 15 vol % or possibly still higher. Additionally or alternately, the combined amount of H₂ and CO in the anode output stream can be 4.0 vol % or more, or 6.0 vol % or more, or 10 vol % or more, such as up to 20 vol % or possibly still higher. Optionally, when the fuel cell is operated with low fuel utilization, the H₂ content in the anode output stream can be in a higher range, such as an H₂ content of 10 vol % to 25 vol %. In such aspects, the syngas content of the anode output stream can be correspondingly higher, such as a combined H₂ and CO content of 15 vol % to 35 vol %. Depending on the aspect, the anode can be operated to increase the amount of electrical energy generated, to increase the amount of chemical energy generated, (i.e., H₂ generated by reforming that is available in the anode output stream), or operated using any other convenient strategy that is compatible with operating the fuel cell to cause alternative ion transport.

In addition to having sufficient H₂ concentration in the anode, one or more locations within the cathode need to have a low enough CO₂ concentration so that the more favorable pathway of carbonate ion transport is not readily available. In some aspects, this can correspond to having a CO₂ concentration in the cathode outlet stream (i.e., cathode exhaust) of 2.0 vol % or less, or 1.0 vol % or less, or 0.8 vol % or less. It is noted that due to variations within the cathode, an average concentration of 2.0 vol % or less (or 1.0 vol % or less, or 0.8 vol % or less) in the cathode exhaust can correspond to a still lower CO₂ concentration in localized regions of the cathode. For example, in a cross-flow configuration, at a corner of the fuel cell that is adjacent to the anode inlet and the cathode outlet, the CO₂ concentration can be lower than a corner of the same fuel cell that is adjacent to the anode outlet and the cathode outlet. Similar localized variations in CO₂ concentration can also occur in fuel cells having a co-current or counter-current configuration.

In addition to having a low concentration of CO₂, the localized region of the cathode can also have 1.0 vol % or more of O₂, or 2.0 vol % or more. In the fuel cell, O₂ is used to form the hydroxide ion that allows for alternative ion transport. If sufficient O₂ is not present, the fuel cell will not operate, as both the carbonate ion transport and alternative ion transport mechanisms are dependent on O₂ availability. With regard to O₂ in the cathode input stream, in some aspects this can correspond to an oxygen content of 4.0 vol % to 15 vol %, or 6.0 vol % to 10 vol %.

It has been observed that a sufficient amount of water should also be present for alternative ion transport to occur, such as 1.0 vol % or more, or 2.0 vol % or more. Without being bound by any particular theory, if water is not available in the cathode when attempting to operate with substantial alternative ion transport, the fuel cell appears to degrade at a much more rapid rate than the deactivation rate that is observed due to alternative ion transport with sufficient water available. It is noted that because air is commonly used as an O₂ source, and since H₂O is one of the products generated during combustion, a sufficient amount of water is typically available within the cathode.

Due to the non-uniform distribution of cathode gas and/or anode gas during operation of a molten carbonate fuel cell for elevated CO₂ capture, it is believed that one or more of the corners and/or edges of the molten carbonate fuel cell will typically have a substantially higher density of alternative ion transport. The one or more corners can correspond to locations where the CO₂ concentration in the cathode is lower than average, or a location where the H₂ concentration in the anode is greater than average, or a combination thereof.

### Example of Molten Carbonate Fuel Cell Operation

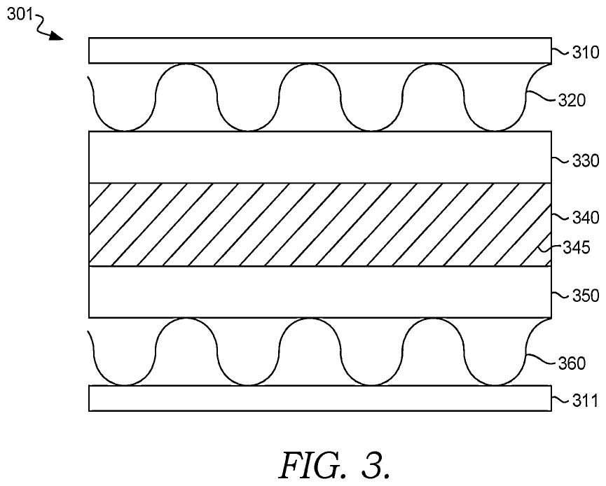

FIG. 3 shows a general example of a portion of a molten carbonate fuel cell stack. The portion of the stack shown in FIG. 3 corresponds to a fuel cell 301. In order to isolate the fuel cell from adjacent fuel cells in the stack and/or other elements in the stack, the fuel cell includes separator plates 310 and 311. In FIG. 3, the fuel cell 301 includes an anode 330 and a cathode 350 that are separated by an electrolyte matrix 340 that contains an electrolyte 342. In various aspects, cathode 350 can correspond to a dual-layer (or multi-layer) cathode. Anode collector 320 provides electrical contact between anode 330 and the separator plate 310, while cathode collector 360 provides similar electrical contact between cathode 350 and the separator plate 311 in the fuel cell stack. Additionally, anode collector 320 allows for introduction and exhaust of gases from anode 330, while cathode collector 360 allows for introduction and exhaust of gases from cathode 350. As mentioned, the exhaust gases from anode 330 may include alkalis that are trapped by the technology described herein.

During operation, CO₂ is passed into the cathode collector 360 along with O₂. The CO₂ and O₂ diffuse into the porous cathode 350 and travel to a cathode interface region near the boundary of cathode 350 and electrolyte matrix 340. In the cathode interface region, a portion of electrolyte 342 can be present in the pores of cathode 350. The CO₂ and O₂ can be converted near/in the cathode interface region to carbonate ion (CO₃²⁻), which can then be transported across electrolyte 342 (and therefore across electrolyte matrix 340) to facilitate generation of electrical current. In aspects where alternative ion transport is occurring, a portion of the O₂ can be converted to an alternative ion, such as a hydroxide ion or a peroxide ion, for transport in electrolyte 342. After transport across the electrolyte 342, the carbonate ion (or alternative ion) can reach an anode interface region near the boundary of electrolyte matrix 340 and anode 330. The carbonate ion can be converted back to CO₂ and H₂O in the presence of H₂, releasing electrons that are used to form the current generated by the fuel cell. The H₂ and/or a hydrocarbon suitable for forming H₂ are introduced into anode 330 via anode collector 320.

In some aspects, any convenient type of electrolyte suitable for operation of a molten carbonate fuel cell can be used. Many conventional MCFCs use a eutectic carbonate mixture as the carbonate electrolyte, such as a eutectic mixture of 62 mol % lithium carbonate and 38 mol % potassium carbonate (62% Li₂CO₃/38% K₂CO₃) or a eutectic mixture of 52 mol % lithium carbonate and 48 mol % sodium carbonate (52% Li₂CO₃/48% Na₂CO₃). Other eutectic mixtures are also available, such as a eutectic mixture of 40 mol % lithium carbonate and 60 mol % potassium carbonate (40% Li₂CO₃/60% K₂CO₃). While eutectic mixtures of carbonate can be convenient as an electrolyte for various reasons, non-eutectic mixtures of carbonates can also be suitable. Generally, such non-eutectic mixtures can include various combinations of lithium carbonate, sodium carbonate, and/or potassium carbonate. Optionally, lesser amounts of other metal carbonates can be included in the electrolyte as additives, such as other alkali carbonates or other types of metal carbonates such as barium carbonate, bismuth carbonate, lanthanum carbonate, or tantalum carbonate.

The flow direction within the anode of a molten carbonate fuel cell can have any convenient orientation relative to the flow direction within a cathode. One option can be to use a cross-flow configuration, so that the flow direction within the anode is roughly at a 900 angle relative to the flow direction within the cathode. This type of flow configuration can have practical benefits, as using a cross-flow configuration can allow the manifolds and/or piping for the anode inlets/outlets to be located on different sides of a fuel cell stack from the manifolds and/or piping for the cathode inlets/outlets. Another option is a counter-flow configuration where the anode flow and cathode flow are parallel to each other, but in an opposite direction. Co-flow is a third possibility. In co-flow, the anode flow and cathode flow are parallel to each other and in the same direction.

### Anode Inputs and Outputs

In various aspects, the anode input stream for an MCFC can include hydrogen, a hydrocarbon such as methane, a hydrocarbonaceous or hydrocarbon-like compound that may contain heteroatoms different from C and H, or a combination thereof. The source of the hydrogen/hydrocarbon/hydrocarbon-like compounds can be referred to as a fuel source. In some aspects, most of the methane (or other hydrocarbon, hydrocarbonaceous, or hydrocarbon-like compound) fed to the anode can typically be fresh methane. In this description, a fresh fuel such as fresh methane refers to a fuel that is not recycled from another fuel cell process. For example, methane recycled from the anode outlet stream back to the anode inlet may not be considered “fresh” methane, and can instead be described as reclaimed methane.

The fuel source used can be shared with other components, such as a turbine that uses a portion of the fuel source to provide a CO₂-containing stream for the cathode input. The fuel source input can include water in a proportion to the fuel appropriate for reforming the hydrocarbon (or hydrocarbon-like) compound in the reforming section that generates hydrogen. For example, if methane is the fuel input for reforming to generate H₂, the molar ratio of water to fuel can be from about one to one to about ten to one, such as at least about two to one. A ratio of four to one or greater is typical for external reforming, but lower values can be typical for internal reforming. To the degree that H₂ is a portion of the fuel source, in some optional aspects no additional water may be needed in the fuel, as the oxidation of H₂ at the anode can tend to produce H₂O that can be used for reforming the fuel. The fuel source can also optionally contain components incidental to the fuel source (e.g., a natural gas feed can contain some content of CO₂ as an additional component). For example, a natural gas feed can contain CO₂, N₂, and/or other inert (noble) gases as additional components. Optionally, in some aspects the fuel source may also contain CO, such as CO from a recycled portion of the anode exhaust. An additional or alternate potential source for CO in the fuel into a fuel cell assembly can be CO generated by steam reforming of a hydrocarbon fuel performed on the fuel prior to entering the fuel cell assembly.

More generally, a variety of types of fuel streams may be suitable for use as an anode input stream for the anode of a molten carbonate fuel cell. Some fuel streams can correspond to streams containing hydrocarbons and/or hydrocarbon-like compounds that may also include heteroatoms different from C and H. In this discussion, unless otherwise specified, a reference to a fuel stream containing hydrocarbons for an MCFC anode is defined to include fuel streams containing such hydrocarbon-like compounds. Examples of hydrocarbon (including hydrocarbon-like) fuel streams include natural gas, streams containing C1-C4 carbon compounds (such as methane or ethane), and streams containing heavier C5+ hydrocarbons (including hydrocarbon-like compounds), as well as combinations thereof. Still other additional or alternate examples of potential fuel streams for use in an anode input can include biogas-type streams, such as methane produced from natural (biological) decomposition of organic material.

In some aspects, a molten carbonate fuel cell can be used to process an input fuel stream, such as a natural gas and/or hydrocarbon stream, with a low energy content due to the presence of diluent compounds. For example, some sources of methane and/or natural gas are sources that can include substantial amounts of either CO₂ or other inert molecules, such as nitrogen, argon, or helium. Due to the presence of elevated amounts of CO₂ and/or inerts, the energy content of a fuel stream based on the source can be reduced. Using a low energy content fuel for a combustion reaction (such as for powering a combustion-powered turbine) can pose difficulties. However, a molten carbonate fuel cell can generate power based on a low energy content fuel source with a reduced or minimal impact on the efficiency of the fuel cell. The presence of additional gas volume can require additional heat for raising the temperature of the fuel to the temperature for reforming and/or the anode reaction. Additionally, due to the equilibrium nature of the water gas shift reaction within a fuel cell anode, the presence of additional CO₂ can have an impact on the relative amounts of H₂ and CO present in the anode output. However, the inert compounds otherwise can have only a minimal direct impact on the reforming and anode reactions. The amount of CO₂ and/or inert compounds in a fuel stream for a molten carbonate fuel cell, when present, can be at least about 1 vol %, such as at least about 2 vol %, or at least about 5 vol %, or at least about 10 vol %, or at least about 15 vol %, or at least about 20 vol %, or at least about 25 vol %, or at least about 30 vol %, or at least about 35 vol %, or at least about 40 vol %, or at least about 45 vol %, or at least about 50 vol %, or at least about 75 vol %. Additionally or alternately, the amount of CO₂ and/or inert compounds in a fuel stream for a molten carbonate fuel cell can be about 90 vol % or less, such as about 75 vol % or less, or about 60 vol % or less, or about 50 vol % or less, or about 40 vol % or less, or about 35 vol % or less.

Yet other examples of potential sources for an anode input stream can correspond to refinery and/or other industrial process output streams. For example, coking is a common process in many refineries for converting heavier compounds to lower boiling ranges. Coking typically produces an off-gas containing a variety of compounds that are gases at room temperature, including CO and various C₁-C₄ hydrocarbons. This off-gas can be used as at least a portion of an anode input stream. Other refinery off-gas streams can additionally or alternately be suitable for inclusion in an anode input stream, such as light ends (C₁-C₄) generated during cracking or other refinery processes. Still other suitable refinery streams can additionally or alternately include refinery streams containing CO or CO₂ that also contain H₂ and/or reformable fuel compounds.

Still other potential sources for an anode input can additionally or alternately include streams with increased water content. For example, an ethanol output stream from an ethanol plant (or another type of fermentation process) can include a substantial portion of H₂O prior to final distillation. Such H₂O can typically cause only minimal impact on the operation of a fuel cell. Thus, a fermentation mixture of alcohol (or other fermentation product) and water can be used as at least a portion of an anode input stream.

Biogas, or digester gas, is another additional or alternate potential source for an anode input. Biogas may primarily comprise methane and CO₂ and is typically produced by the breakdown or digestion of organic matter. Anaerobic bacteria may be used to digest the organic matter and produce the biogas. Impurities, such as sulfur-containing compounds, may be removed from the biogas prior to use as an anode input.

The output stream from an MCFC anode can include H₂O, CO₂, CO, and H₂. Optionally, the anode output stream could also have unreacted fuel (such as H₂ or CH₄) or inert compounds in the feed as additional output components. Instead of using this output stream as a fuel source to provide heat for a reforming reaction or as a combustion fuel for heating the cell, one or more separations can be performed on the anode output stream to separate the CO₂ from the components with potential value as inputs to another process, such as H₂ or CO. The H₂ and/or CO can be used as a syngas for chemical synthesis, as a source of hydrogen for chemical reaction, and/or as a fuel with reduced greenhouse gas emissions.

### Cathode Inputs and Outputs

Conventionally, a molten carbonate fuel cell can be operated based on drawing a desired load while consuming some portion of the fuel in the fuel stream delivered to the anode. The voltage of the fuel cell can then be determined by the load, fuel input to the anode, air and CO₂ provided to the cathode, and the internal resistances of the fuel cell. The CO₂ to the cathode can be conventionally provided in part by using the anode exhaust as at least a part of the cathode input stream. By contrast, the present invention can use separate/different sources for the anode input and cathode input. By removing any direct link between the composition of the anode input flow and the cathode input flow, additional options become available for operating the fuel cell, such as to generate excess synthesis gas, to improve capture of carbon dioxide, and/or to improve the total efficiency (electrical plus chemical power) of the fuel cell, among others.

In various aspects, an MCFC can be operated to cause alternative ion transport across the electrolyte for the fuel cell. In order to cause alternative ion transport, the CO₂ content of the cathode input stream can be 5.0 vol % or less, or 4.0 vol % or less, such as 1.5 vol % to 5.0 vol %, or 1.5 vol % to 4.0 vol %, or 2.0 vol % to 5.0 vol %, or 2.0 vol % to 4.0 vol %.

One example of a suitable CO₂-containing stream for use as a cathode input flow can be an output or exhaust flow from a combustion source. Examples of combustion sources include, but are not limited to, sources based on combustion of natural gas, combustion of coal, and/or combustion of other hydrocarbon-type fuels (including biologically derived fuels). Additional or alternate sources can include other types of boilers, fired heaters, furnaces, and/or other types of devices that burn carbon-containing fuels in order to heat another substance (such as water or air).

Other potential sources for a cathode input stream can additionally or alternately include sources of bio-produced CO₂. This can include, for example, CO₂ generated during processing of bio-derived compounds, such as CO₂ generated during ethanol production. An additional or alternate example can include CO₂ generated by combustion of a bio-produced fuel, such as combustion of lignocellulose. Still other additional or alternate potential CO₂ sources can correspond to output or exhaust streams from various industrial processes, such as CO₂-containing streams generated by plants for manufacture of steel, cement, and/or paper.

Yet another additional or alternate potential source of CO₂ can be CO₂-containing streams from a fuel cell. The CO₂-containing stream from a fuel cell can correspond to a cathode output stream from a different fuel cell, an anode output stream from a different fuel cell, a recycle stream from the cathode output to the cathode input of a fuel cell, and/or a recycle stream from an anode output to a cathode input of a fuel cell. For example, an MCFC operated in standalone mode under conventional conditions can generate a cathode exhaust with a CO₂ concentration of at least about 5 vol %. Such a CO₂-containing cathode exhaust could be used as a cathode input for an MCFC operated according to an aspect of the invention. More generally, other types of fuel cells that generate a CO₂ output from the cathode exhaust can additionally or alternately be used, as well as other types of CO₂-containing streams not generated by a “combustion” reaction and/or by a combustion-powered generator. Optionally but preferably, a CO₂-containing stream from another fuel cell can be from another molten carbonate fuel cell. For example, for molten carbonate fuel cells connected in series with respect to the cathodes, the output from the cathode for a first molten carbonate fuel cell can be used as the input to the cathode for a second molten carbonate fuel cell.

In addition to CO₂, a cathode input stream can include O₂ to provide the components necessary for the cathode reaction. Some cathode input streams can be based on having air as a component. For example, a combustion exhaust stream can be formed by combusting a hydrocarbon fuel in the presence of air. Such a combustion exhaust stream, or another type of cathode input stream having an oxygen content based on inclusion of air, can have an oxygen content of about 20 vol % or less, such as about 15 vol % or less, or about 10 vol % or less. Additionally or alternately, the oxygen content of the cathode input stream can be at least about 4 vol %, such as at least about 6 vol %, or at least about 8 vol %. More generally, a cathode input stream can have a suitable content of oxygen for performing the cathode reaction. In some aspects, this can correspond to an oxygen content of about 5 vol % to about 15 vol %, such as from about 7 vol % to about 9 vol %. For many types of cathode input streams, the combined amount of CO₂ and O₂ can correspond to less than about 21 vol % of the input stream, such as less than about 15 vol % of the stream or less than about 10 vol % of the stream. An air stream containing oxygen can be combined with a CO₂ source that has low oxygen content. For example, the exhaust stream generated by burning coal may include a low oxygen content that can be mixed with air to form a cathode inlet stream.

In addition to CO₂ and O₂, a cathode input stream can also be composed of inert/non-reactive species such as N₂, H₂O, and other typical oxidant (air) components. For example, for a cathode input derived from an exhaust from a combustion reaction, if air is used as part of the oxidant source for the combustion reaction, the exhaust gas can include typical components of air such as N₂, H₂O, and other compounds in minor amounts that are present in air. Depending on the nature of the fuel source for the combustion reaction, additional species present after combustion based on the fuel source may include one or more of H₂O, oxides of nitrogen (NOx) and/or sulfur (SOx), and other compounds either present in the fuel and/or that are partial or complete combustion products of compounds present in the fuel, such as CO. These species may be present in amounts that do not poison the cathode catalyst surfaces though they may reduce the overall cathode activity. Such reductions in performance may be acceptable, or species that interact with the cathode catalyst may be reduced to acceptable levels by known pollutant removal technologies.

The amount of O₂ present in a cathode input stream (such as an input cathode stream based on a combustion exhaust) can advantageously be sufficient to provide the oxygen needed for the cathode reaction in the fuel cell. Thus, the volume percentage of O₂ can advantageously be at least 0.5 times the amount of CO₂ in the exhaust. Optionally, as necessary, additional air can be added to the cathode input to provide sufficient oxidant for the cathode reaction. When some form of air is used as the oxidant, the amount of N₂ in the cathode exhaust can be at least about 78 vol %, e.g., at least about 88 vol %, and/or about 95 vol % or less. In some aspects, the cathode input stream can additionally or alternately contain compounds that are generally viewed as contaminants, such as H₂S or NH₃. In other aspects, the cathode input stream can be cleaned to reduce or minimize the content of such contaminants.

A suitable temperature for operation of an MCFC can be between about 450° C. and about 750° C., such as at least about 500° C., e.g., with an inlet temperature of about 550° C. and an outlet temperature of about 625° C. Prior to entering the cathode, heat can be added to or removed from the cathode input stream, if desired, e.g., to provide heat for other processes, such as reforming the fuel input for the anode. For example, if the source for the cathode input stream is a combustion exhaust stream, the combustion exhaust stream may have a temperature greater than a desired temperature for the cathode inlet. In such an aspect, heat can be removed from the combustion exhaust prior to use as the cathode input stream. Alternatively, the combustion exhaust could be at very low temperature, for example after a wet gas scrubber on a coal-fired boiler, in which case the combustion exhaust can be below about 100° C. Alternatively, the combustion exhaust could be from the exhaust of a gas turbine operated in combined cycle mode, in which the gas can be cooled by raising steam to run a steam turbine for additional power generation. In this case, the gas can be below about 50° C. Heat can be added to a combustion exhaust that is cooler than desired.

### Additional Molten Carbonate Fuel Cell Operating Strategies

In some aspects, when operating an MCFC to cause alternative ion transport, the anode of the fuel cell can be operated at a traditional fuel utilization value of roughly 60% to 80%. When attempting to generate electrical power, operating the anode of the fuel cell at a relatively high fuel utilization can be beneficial for improving electrical efficiency (i.e., electrical energy generated per unit of chemical energy consumed by the fuel cell).

In some aspects, it may be beneficial to reduce the electrical efficiency of the fuel cell in order to provide other benefits, such as an increase in the amount of H₂ provided in the anode output flow. This can be beneficial, for example, if it is desirable to consume excess heat generated in the fuel cell (or fuel cell stack) by performing additional reforming and/or performing another endothermic reaction. For example, a molten carbonate fuel cell can be operated to provide increased production of syngas and/or hydrogen. The heat required for performing the endothermic reforming reaction can be provided by the exothermic electrochemical reaction in the anode for electricity generation. Rather than attempting to transport the heat generated by the exothermic fuel cell reaction(s) away from the fuel cell, this excess heat can be used in situ as a heat source for reforming and/or another endothermic reaction. This can result in more efficient use of the heat energy and/or a reduced need for additional external or internal heat exchange. This efficient production and use of heat energy, essentially in-situ, can reduce system complexity and components while maintaining advantageous operating conditions. In some aspects, the amount of reforming or other endothermic reaction can be selected to have an endothermic heat requirement comparable to, or even greater than, the amount of excess heat generated by the exothermic reaction(s) rather than significantly less than the heat requirement typically described in the prior art.

Additionally or alternately, the fuel cell can be operated so that the temperature differential between the anode inlet and the anode outlet can be negative rather than positive. Thus, instead of having a temperature increase between the anode inlet and the anode outlet, a sufficient amount of reforming and/or other endothermic reaction can be performed to cause the output stream from the anode outlet to be cooler than the anode inlet temperature. Further additionally or alternately, additional fuel can be supplied to a heater for the fuel cell and/or an internal reforming stage (or other internal endothermic reaction stage) so that the temperature differential between the anode input and the anode output can be smaller than the expected difference based on the relative demand of the endothermic reaction(s) and the combined exothermic heat generation of the cathode combustion reaction and the anode reaction for generating electrical power. In aspects where reforming is used as the endothermic reaction, operating a fuel cell to reform excess fuel can allow for production of increased synthesis gas and/or increased hydrogen relative to conventional fuel cell operation while minimizing the system complexity for heat exchange and reforming. The additional synthesis gas and/or additional hydrogen can then be used in a variety of applications, including chemical synthesis processes and/or collection/repurposing of hydrogen for use as a “clean” fuel.

The amount of heat generated per mole of hydrogen oxidized by the exothermic reaction at the anode can be substantially larger than the amount of heat consumed per mole of hydrogen generated by the reforming reaction. The net reaction for hydrogen in a molten carbonate fuel cell (H₂+½ O₂=>H₂O) can have an enthalpy of reaction of about −285 kJ/mol of hydrogen molecules. At least a portion of this energy can be converted to electrical energy within the fuel cell. However, the difference (approximately) between the enthalpy of reaction and the electrical energy produced by the fuel cell can become heat within the fuel cell. This quantity of energy can alternatively be expressed as the current density (current per unit area) for the cell multiplied by the difference between the theoretical maximum voltage of the fuel cell and the actual voltage, or <current density>*(Vmax−Vact). This quantity of energy is defined as the “waste heat” for a fuel cell. As an example of reforming, the enthalpy of reforming for methane (CH₄+2H₂O=>4H₂+CO₂) can be about 250 kJ/mol of methane, or about 62 kJ/mol of hydrogen molecules. From a heat balance standpoint, each hydrogen molecule electrochemically oxidized can generate sufficient heat to generate more than one hydrogen molecule by reforming. In a conventional configuration, this excess heat can result in a substantial temperature difference from anode inlet to anode outlet. Instead of allowing this excess heat to be used for increasing the temperature in the fuel cell, the excess heat can be consumed by performing a matching amount of the reforming reaction. The excess heat generated in the anode can be supplemented with the excess heat generated by the combustion reaction in the fuel cell. More generally, the excess heat can be consumed by performing an endothermic reaction in the fuel cell anode and/or in an endothermic reaction stage heat integrated with the fuel cell.

Depending on the aspect, the amount of reforming and/or other endothermic reaction can be selected relative to the amount of hydrogen reacted in the anode in order to achieve a desired thermal ratio for the fuel cell. As used herein, the “thermal ratio” is defined as the heat produced by exothermic reactions in a fuel cell assembly (including exothermic reactions in both the anode and cathode) divided by the endothermic heat demand of reforming reactions occurring within the fuel cell assembly. Expressed mathematically, the thermal ratio (TH)=Q_{EX}/Q_{EN}, where Q_{EX} is the sum of heat produced by exothermic reactions and Q_{EN} is the sum of heat consumed by the endothermic reactions occurring within the fuel cell. Note that the heat produced by the exothermic reactions can correspond to any heat due to reforming reactions, water gas shift reactions, combustion reactions (i.e., oxidation of fuel compounds) in the cathode, and/or the electrochemical reactions in the cell. The heat generated by the electrochemical reactions can be calculated based on the ideal electrochemical potential of the fuel cell reaction across the electrolyte minus the actual output voltage of the fuel cell. For example, the ideal electrochemical potential of the reaction in an MCFC is believed to be about 1.04 V based on the net reaction that occurs in the cell. During operation of the MCFC, the cell can typically have an output voltage less than 1.04 V due to various losses. For example, a common output/operating voltage can be about 0.7 V. The heat generated can be equal to the electrochemical potential of the cell (i.e., ˜1.04 V) minus the operating voltage. For example, the heat produced by the electrochemical reactions in the cell can be ˜0.34 V when the output voltage of ˜0.7 V is attained in the fuel cell. Thus, in this scenario, the electrochemical reactions would produce ˜0.7 V of electricity and ˜0.34 V of heat energy. In such an example, the ˜0.7 V of electrical energy is not included as part of Q_{EX}. In other words, heat energy is not electrical energy.

In various aspects, a thermal ratio can be determined for any convenient fuel cell structure, such as a fuel cell stack, an individual fuel cell within a fuel cell stack, a fuel cell stack with an integrated reforming stage, a fuel cell stack with an integrated endothermic reaction stage, or a combination thereof. The thermal ratio may also be calculated for different units within a fuel cell stack, such as an assembly of fuel cells or fuel cell stacks. For example, the thermal ratio may be calculated for a fuel cell (or a plurality of fuel cells) within a fuel cell stack along with integrated reforming stages and/or integrated endothermic reaction stage elements in sufficiently close proximity to the fuel cell(s) to be integrated from a heat integration standpoint.

From a heat integration standpoint, a characteristic width in a fuel cell stack can be the height of an individual fuel cell stack element. It is noted that the separate reforming stage and/or a separate endothermic reaction stage could have a different height in the stack than a fuel cell. In such a scenario, the height of a fuel cell element can be used as the characteristic height. In this discussion, an integrated endothermic reaction stage can be defined as a stage heat integrated with one or more fuel cells, so that the integrated endothermic reaction stage can use the heat from the fuel cells as a heat source for reforming. Such an integrated endothermic reaction stage can be defined as being positioned less than 10 times the height of a stack element from fuel cells providing heat to the integrated stage. For example, an integrated endothermic reaction stage (such as a reforming stage) can be positioned less than 10 times the height of a stack element from any fuel cells that are heat integrated, or less than 8 times the height of a stack element, or less than 5 times the height of a stack element, or less than 3 times the height of a stack element. In this discussion, an integrated reforming stage and/or integrated endothermic reaction stage that represents an adjacent stack element to a fuel cell element is defined as being about one stack element height or less away from the adjacent fuel cell element.

A thermal ratio of about 1.3 or less, or about 1.15 or less, or about 1.0 or less, or about 0.95 or less, or about 0.90 or less, or about 0.85 or less, or about 0.80 or less, or about 0.75 of less, can be lower than the thermal ratio typically sought in use of MCFC fuel cells. In aspects of the invention, the thermal ratio can be reduced to increase and/or optimize syngas generation, hydrogen generation, generation of another product via an endothermic reaction, or a combination thereof.

In various aspects of the invention, the operation of the fuel cells can be characterized based on a thermal ratio. Where fuel cells are operated to have a desired thermal ratio, a molten carbonate fuel cell can be operated to have a thermal ratio of about 1.5 or less, for example about 1.3 or less, or about 1.15 or less, or about 1.0 or less, or about 0.95 or less, or about 0.90 or less, or about 0.85 or less, or about 0.80 or less, or about 0.75 or less. Additionally or alternately, the thermal ratio can be at least about 0.25, or at least about 0.35, or at least about 0.45, or at least about 0.50. Further additionally or alternately, in some aspects the fuel cell can be operated to have a temperature rise between the anode input and anode output of about 40° C. or less, such as about 20° C. or less, or about 10° C. or less. Still further additionally or alternately, the fuel cell can be operated to have an anode outlet temperature that is from about 10° C. lower to about 10° C. higher than the temperature of the anode inlet. Yet further additionally or alternately, the fuel cell can be operated to have an anode inlet temperature greater than the anode outlet temperature, such as at least about 5° C. greater, or at least about 10° C. greater, or at least about 20° C. greater, or at least about 25° C. greater. Still further additionally or alternately, the fuel cell can be operated to have an anode inlet temperature greater than the anode outlet temperature by about 100° C. or less, or about 80° C. or less, or about 60° C. or less, or about 50° C. or less, or about 40° C. or less, or about 30° C. or less, or about 20° C. or less.

Operating a fuel cell with a thermal ratio of less than 1 can cause a temperature drop across the fuel cell. In some aspects, the amount of reforming and/or other endothermic reaction may be limited so that a temperature drop from the anode inlet to the anode outlet can be about 100° C. or less, such as about 80° C. or less, or about 60° C. or less, or about 50° C. or less, or about 40° C. or less, or about 30° C. or less, or about 20° C. or less. Limiting the temperature drop from the anode inlet to the anode outlet can be beneficial, for example, for maintaining a sufficient temperature to allow complete or substantially complete conversion of fuels (by reforming) in the anode. In other aspects, additional heat can be supplied to the fuel cell (such as by heat exchange or combustion of additional fuel) so that the anode inlet temperature is greater than the anode outlet temperature by less than about 100° C. or less, such as about 80° C. or less, or about 60° C. or less, or about 50° C. or less, or about 40° C. or less, or about 30° C. or less, or about 20° C. or less, due to a balancing of the heat consumed by the endothermic reaction and the additional external heat supplied to the fuel cell.

The amount of reforming can additionally or alternately be dependent on the availability of a reformable fuel. For example, if the fuel only comprised H₂, no reformation would occur because H₂ is already reformed and is not further reformable. The amount of “syngas produced” by a fuel cell can be defined as a difference in the lower heating value (LHV) of syngas in the anode input versus an LHV of syngas in the anode output. Syngas produced LHV (sg net)=(LHV(sg out) −LHV(sg in)), where LHV(sg in) and LHV(sg out) refer to the LHV of the syngas in the anode inlet and syngas in the anode outlet streams or flows, respectively. A fuel cell provided with a fuel containing substantial amounts of H₂ can be limited in the amount of potential syngas production, since the fuel contains substantial amounts of already reformed H₂, as opposed to containing additional reformable fuel. The lower heating value is defined as the enthalpy of combustion of a fuel component to vapor phase, fully oxidized products (i.e., vapor phase CO₂ and H₂O product). For example, any CO₂ present in an anode input stream does not contribute to the fuel content of the anode input, since CO₂ is already fully oxidized. For this definition, the amount of oxidation occurring in the anode due to the anode fuel cell reaction is defined as oxidation of H₂ in the anode as part of the electrochemical reaction in the anode.

An example of a method for operating a fuel cell with a reduced thermal ratio can be a method where excess reforming of fuel is performed in order to balance the generation and consumption of heat in the fuel cell and/or consume more heat than is generated. Reforming a reformable fuel to form H₂ and/or CO can be an endothermic process, while the anode electrochemical oxidation reaction and the cathode combustion reaction(s) can be exothermic. During conventional fuel cell operation, the amount of reforming needed to supply the feed components for fuel cell operation can typically consume less heat than the amount of heat generated by the anode oxidation reaction. For example, conventional operation at a fuel utilization of about 70% or about 75% produces a thermal ratio substantially greater than 1, such as a thermal ratio of at least about 1.4 or greater, or 1.5 or greater. As a result, the output streams for the fuel cell can be hotter than the input streams. Instead of this type of conventional operation, the amount of fuel reformed in the reforming stages associated with the anode can be increased. For example, additional fuel can be reformed so that the heat generated by the exothermic fuel cell reactions can either be (roughly) balanced by the heat consumed in reforming and/or consume more heat than is generated. This can result in a substantial excess of hydrogen relative to the amount oxidized in the anode for electrical power generation and result in a thermal ratio of about 1.0 or less, such as about 0.95 or less, or about 0.90 or less, or about 0.85 or less, or about 0.80 or less, or about 0.75 or less.

Either hydrogen or syngas can be withdrawn from the anode exhaust as a chemical energy output. Hydrogen can be used as a clean fuel without generating greenhouse gases when it is burned or combusted. Instead, for hydrogen generated by reforming of hydrocarbons (or hydrocarbonaceous compounds), the CO₂ will have already been “captured” in the anode loop. Additionally, hydrogen can be a valuable input for a variety of refinery processes and/or other synthesis processes. Syngas can also be a valuable input for a variety of processes. In addition to having fuel value, syngas can be used as a feedstock for producing other higher value products, such as by using syngas as an input for Fischer-Tropsch synthesis and/or methanol synthesis processes.

In some aspects, the reformable hydrogen content of reformable fuel in the input stream delivered to the anode and/or to a reforming stage associated with the anode can be at least about 50% greater than the net amount of hydrogen reacted at the anode, such as at least about 75% greater or at least about 100% greater. Additionally or alternately, the reformable hydrogen content of fuel in the input stream delivered to the anode and/or to a reforming stage associated with the anode can be at least about 50% greater than the net amount of hydrogen reacted at the anode, such as at least about 75% greater or at least about 100% greater. In various aspects, a ratio of the reformable hydrogen content of the reformable fuel in the fuel stream relative to an amount of hydrogen reacted in the anode can be at least about 1.5:1, or at least about 2.0:1, or at least about 2.5:1, or at least about 3.0:1. Additionally or alternately, the ratio of reformable hydrogen content of the reformable fuel in the fuel stream relative to the amount of hydrogen reacted in the anode can be about 20:1 or less, such as about 15:1 or less or about 10:1 or less. In one aspect, it is contemplated that less than 100% of the reformable hydrogen content in the anode inlet stream can be converted to hydrogen. For example, at least about 80% of the reformable hydrogen content in an anode inlet stream can be converted to hydrogen in the anode and/or in an associated reforming stage(s), such as at least about 85%, or at least about 90%. Additionally or alternately, the amount of reformable fuel delivered to the anode can be characterized based on the lower heating value (LHV) of the reformable fuel relative to the LHV of the hydrogen oxidized in the anode. This can be referred to as a reformable fuel surplus ratio. In various aspects, the reformable fuel surplus ratio can be at least about 2.0, such as at least about 2.5, or at least about 3.0, or at least about 4.0. Additionally or alternately, the reformable fuel surplus ratio can be about 25.0 or less, such as about 20.0 or less, or about 15.0 or less, or about 10.0 or less.

### Additional Embodiments

Embodiment 1. A method for producing electricity in a molten carbonate fuel cell, the method comprising: introducing an anode input stream comprising H₂, a reformable fuel, or a combination thereof into an anode gas-collection volume, the anode gas-collection volume being defined by an anode surface, a first separator plate, and an anode collector providing support between the anode surface and the first separator plate; introducing a cathode input stream comprising O₂ and CO₂ into a cathode gas-collection volume, the cathode gas-collection volume being defined by a cathode surface, a second separator plate, and a cathode collector providing support between the cathode surface and the second separator plate; and operating the molten carbonate fuel cell to generate electricity, an anode exhaust and a cathode exhaust comprising, wherein the anode gas-collection volume includes one or more surfaces comprising a reforming catalyst and one or more surfaces comprising an alkali trap, the alkali trap comprising a material capable of adsorbing alkali.

Embodiment 2. The method of embodiment 1, wherein the material of the alkali trap is selected from the group consisting of an alumina, silica, silica-alumina, and alumino-silicates.

Embodiment 3. The method of embodiment 2, wherein the material of the alkali trap comprises a zeolite with a H⁺ cation.

Embodiment 4. The method of embodiment 2, wherein the material of the alkali trap comprises a zeolite with a 15:1 ratio of SiO₂ to Al₂O₃.

Embodiment 5. The method of embodiment 2, wherein 70% or more of the material of the alkali trap has a crystal size between 0.2-0.4 μm.

Embodiment 6. The method as in any one of the preceding embodiments, wherein the anode collector comprises an undulating loop pattern forming top-facing pockets and bottom-facing pockets, wherein top-facing pockets are open to the anode surface and bottom facing pockets are open to separator plate.

Embodiment 7. The method of embodiment 6, wherein the alkali trap is provided within the top-facing pockets.

Embodiment 8. The method of embodiment 7, wherein the reforming catalyst is provided within the bottom-facing pockets.

Embodiment 9. The method as in any one of the preceding embodiments, wherein the alkali trap is positioned within the anode collector to contact alkali vapor exiting the anode surface before the alkali vapor contacts the reforming catalyst.

Embodiment 10. The method as in any one of the preceding embodiments, wherein the reforming catalyst is a Ni catalyst.

Embodiment 11. The method as in any one of the preceding embodiments, wherein the molten carbonate fuel cell is operated at a transference of 0.97 or less and an average current density of 60 mA/cm² or more.

Embodiment 12. The method as in any one of the preceding embodiments, wherein a H₂ concentration in the anode exhaust is 5.0 vol % or more, or wherein a combined concentration of H₂ and CO in the anode exhaust is 6.0 vol % or more, or a combination thereof.

Embodiment 13. A molten carbonate fuel cell, comprising: an anode; a first separator plate; an anode collector in contact with the anode and the first separator plate to define an anode gas-collection volume between the anode and the first separator plate, the anode gas-collection volume being in fluid communication with an anode inlet; an alkali trap in contact with a surface on the anode collector, the alkali trap comprising a material capable of adsorbing alkali; a cathode; a second separator plate; a cathode collector in contact with a cathode surface of the cathode and the second separator plate to define a cathode gas-collection volume between the cathode and the second separator plate, the cathode gas-collection volume being in fluid communication with a cathode inlet; and an electrolyte matrix comprising an electrolyte between the anode and the cathode.

Embodiment 14. The molten carbonate fuel cell of embodiment 13, further comprising a reforming catalyst in contact with the anode collector.

Embodiment 15. The molten carbonate fuel cell of as in any one of embodiments 13 and 14, wherein the anode collector comprises an undulating loop pattern forming top-facing pockets and bottom-facing pockets, wherein top-facing pockets are open to a surface of the anode and bottom facing pockets are open to separator plate.

Embodiment 16. The molten carbonate fuel cell of embodiment 15, wherein the alkali trap is located within the top-facing pockets.

Embodiment 17. The molten carbonate fuel cell of embodiment 16, wherein a reforming catalyst is provided within the bottom-facing pockets.

Embodiment 18. The molten carbonate fuel cell of as in any one of embodiments 13, 14, 15, 16, and 17, wherein the alkali trap comprises a material selected from the group consisting of an alumina, silica-alumina, and alumino-silicate.

Embodiment 19. The molten carbonate fuel cell as in any one of embodiments 13, 14, 15, 16, 17 and 18, wherein the alkali trap is positioned within the anode collector in a flow path starting at a surface of the anode and ending at a reforming catalyst.

Embodiment 20. The molten carbonate fuel cell as in any one of embodiments 13, 14, 15, 16, 17, 18, and 19, wherein the alkali trap is positioned within the anode collector without material between the alkali trap and an anode surface.

All numerical values within the detailed description and the claims herein are modified by “about” or “approximately” the indicated value, and take into account experimental error and variations that would be expected by a person having ordinary skill in the art.

Although the present invention has been described in terms of specific embodiments, it is not necessarily so limited. Suitable alterations/modifications for operation under specific conditions should be apparent to those skilled in the art. It is therefore intended that the following claims be interpreted as covering all such alterations/modifications that fall within the true spirit/scope of the invention.

1. A method for producing electricity in a molten carbonate fuel cell, the method comprising:
introducing an anode input stream comprising H₂, a reformable fuel, or a combination thereof into an anode gas-collection volume, the anode gas-collection volume being defined by an anode surface, a first separator plate, and an anode collector providing support between the anode surface and the first separator plate;
introducing a cathode input stream comprising O₂ and CO₂ into a cathode gas-collection volume, the cathode gas-collection volume being defined by a cathode surface, a second separator plate, and a cathode collector providing support between the cathode surface and the second separator plate; and
operating the molten carbonate fuel cell to generate electricity, an anode exhaust and a cathode exhaust comprising,
wherein the anode gas-collection volume includes one or more surfaces comprising a reforming catalyst and one or more surfaces comprising an alkali trap, the alkali trap comprising a material capable of adsorbing alkali.

2. The method of claim 1, wherein the material of the alkali trap is selected from the group consisting of an alumina, silica, silica-alumina, and alumino-silicates.

3. The method of claim 2, wherein the material of the alkali trap comprises a zeolite with a H⁺ cation.

4. The method of claim 2, wherein the material of the alkali trap comprises a zeolite with a 15:1 ratio of SiO₂ to Al₂O₃.

5. The method of claim 2, wherein 70% or more of the material of the alkali trap has a crystal size between 0.2-0.4 μm.

6. The method of claim 1, wherein the anode collector comprises an undulating loop pattern forming top-facing pockets and bottom-facing pockets, wherein top-facing pockets are open to the anode surface and bottom facing pockets are open to separator plate.

7. The method of claim 6, wherein the alkali trap is provided within the top-facing pockets.

8. The method of claim 7, wherein the reforming catalyst is provided within the bottom-facing pockets.

9. The method of claim 1, wherein the alkali trap is positioned within the anode collector to contact alkali vapor exiting the anode surface before the alkali vapor contacts the reforming catalyst.

10. The method of claim 1, wherein the reforming catalyst is a Ni catalyst.

11. The method of claim 1, wherein the molten carbonate fuel cell is operated at a transference of 0.97 or less and an average current density of 60 mA/cm² or more.

12. The method of claim 1, wherein a H₂ concentration in the anode exhaust is 5.0 vol % or more, or wherein a combined concentration of H₂ and CO in the anode exhaust is 6.0 vol % or more, or a combination thereof.

13. A molten carbonate fuel cell, comprising:
an anode;
a first separator plate;
an anode collector in contact with the anode and the first separator plate to define an anode gas-collection volume between the anode and the first separator plate, the anode gas-collection volume being in fluid communication with an anode inlet;
an alkali trap in contact with a surface on the anode collector, the alkali trap comprising a material capable of adsorbing alkali;
a cathode;
a second separator plate;
a cathode collector in contact with a cathode surface of the cathode and the second separator plate to define a cathode gas-collection volume between the cathode and the second separator plate, the cathode gas-collection volume being in fluid communication with a cathode inlet; and
an electrolyte matrix comprising an electrolyte between the anode and the cathode.

14. The molten carbonate fuel cell of claim 13, further comprising a reforming catalyst in contact with the anode collector.

15. The molten carbonate fuel cell of claim 13, wherein the anode collector comprises an undulating loop pattern forming top-facing pockets and bottom-facing pockets, wherein top-facing pockets are open to a surface of the anode and bottom facing pockets are open to separator plate.

16. The molten carbonate fuel cell of claim 15, wherein the alkali trap is located within the top-facing pockets.

17. The molten carbonate fuel cell of claim 16, wherein a reforming catalyst is provided within the bottom-facing pockets.

18. The molten carbonate fuel cell of claim 13, wherein the alkali trap comprises a material selected from the group consisting of an alumina, silica-alumina, and alumino-silicate.

19. The molten carbonate fuel cell of claim 13, wherein the alkali trap is positioned within the anode collector in a flow path starting at a surface of the anode and ending at a reforming catalyst.

20. The molten carbonate fuel cell of claim 13, wherein the alkali trap is positioned within the anode collector without material between the alkali trap and an anode surface.
